(19) United States
(12) Patent Application Publication
(10) Pub. No.: US 2016/0305439 A1
(43) Pub. Date: Oct. 20, 2016

(54) FAN PLATFORM EDGE SEAL

(71) Applicant: UNITED TECHNOLOGIES CORPORATION, Farmington, CT (US)

(72) Inventors: Andrew G. ALARCON, Issaquah, WA (US); William BOGUE, Hebron, CT (US)

(21) Appl. No.: 15/102,062

(22) PCT Filed: Aug. 15, 2014
(86) PCT No.: PCT/US2014/051189

§ 371 Date: Jun. 6, 2016

Related U.S. Application Data
(60) Provisional application No. 61/915,883, filed on Dec. 13, 2013.

(51) Int. Cl. F04D 29/08; F04D 29/38; F04D 29/34; F04D 19/00; F04D 29/32

(52) U.S. Cl. CPC F04D 29/083; F04D 19/002; F04D 29/329; F04D 29/34; F04D 29/38; F05D 2220/32; F05D 2240/80; F05D 2230/23; F05D 2300/43

(57) ABSTRACT

An edge seal for preventing airflow through a space between a fan platform and an adjacent airfoil in a gas turbine engine may include a bonding segment being bondable to the fan platform. A sealing flap converges with the bonding segment so that the sealing flap is operatively contactable with the adjacent airfoil. A bumper rib protrudes from the bonding segment so that the bumper rib is bondable to the fan platform.

### TECHNICAL FIELD

The subject matter of the present disclosure relates generally to gas turbine engines and, more particularly, relates to edge seals for fan platforms used in gas turbine engines.

### BACKGROUND

In certain types of gas turbine engines, the fan rotor includes blades with integral platforms located near the root of the blade. In other types of gas turbine engines with more complex blade designs, non-integral platforms radially extend from the fan rotor between adjacent blades instead. Examples of non-integral platforms include triangular platforms and T-shaped platforms. Because these platforms are non-integral with the blades, spaces are typically established between the platforms and the blades. However, aerodynamic efficiency is lost due to these spaces between the platforms and the blades. In order to improve the aerodynamic efficiency and secondary air flow, these spaces must be sealed.

Conventionally, edge seals are provided on the non-integral platforms to prevent air leakage through these spaces. It is generally difficult, however, to provide edge seals on platforms attached to the fan rotor via an attachment pin because these platforms rotate slightly about the pin during engine operation. As such, traditional edge seals may shift during operation and potentially flap underneath the platform allowing air to leak through the spaces. Further, the traditional edge seals, designed primarily to seal the spaces between the platforms and the blades to prevent air flowing through, are not well adapted to protect the blade from contact with the platform during operation. Contact between the platform and the blade creates contact wear and decreases the life of the blade and the platform requiring more frequent and expensive maintenance and overhaul. While generally effective in preventing air leakage through the spaces, traditional edge seals are not designed to effectively protect against contact between the platform and blade. These traditional edge seals also yield the potential to become displaced during operation creating the possibility of some air to flow through the spaces.

Accordingly, there is a need for edge seals of non-integral platforms to protect an adjacent fan blade from contact with the platform, to eliminate the potential to become displaced during operation and to include a locating feature.

### SUMMARY

In accordance with an aspect of the disclosure, an edge seal for preventing airflow through a space between a fan platform and an adjacent airfoil in a gas turbine engine is provided. The edge seal may include a bonding segment being bondable to the fan platform. A sealing flap may converge with the bonding segment so that the sealing flap is operatively contactable with the adjacent airfoil. A bumper rib may protrude from the bonding segment so that the bumper rib is bondable to the fan platform.

In accordance with another aspect of the disclosure, the seal edge may be covered in fabric.

In accordance with yet another aspect of the disclosure, the fabric may cover a portion of the bonding segment that is bondable to the fan platform, a portion of the bumper rib that is bondable to the fan platform, a portion of the bumper rib which faces the adjacent airfoil, and the sealing flap.

In accordance with still yet another aspect of the disclosure, the fabric may be a polyester weave.

In further accordance with another aspect of the disclosure, the bumper rib may include a rounded end.

In further accordance with yet another aspect of the disclosure, the bumper rib may include a squared end.

In accordance with another aspect of the disclosure, a gas turbine engine is provided. The gas turbine engine may include a plurality of airfoils radially attached circumferentially around a fan rotor. A plurality of fan platforms may be attached to the fan rotor with each of the fan platforms disposed between each of the plurality of airfoils. Each of the fan platforms may include a first and second side edge and an inner surface. Each edge seal of a first plurality of edge seals may include a first bonding segment, a first sealing flap and a first bumper rib. The first bonding segment may be bonded to the inner surface. The first bumper rib may be bonded to the first side edge so that the first sealing flap may be in operatively sealing contact with the airfoil adjacent thereto. Each edge seal of a second plurality of edge seals may include a second bonding segment, a second sealing flap and a second bumper rib. The second bonding segment may be bonded to the inner surface. The second bumper rib may be bonded to the second side edge so that the second sealing flap may be in operatively sealing contact with the airfoil adjacent thereto.

In accordance with yet another aspect of the disclosure, each of the first and second plurality of edge seals may be covered in a fabric.

In accordance with still yet another aspect of the disclosure, the fabric may cover a portion of the first bonding segment that is bonded to the inner surface, a portion of the first bumper rib that is bonded to the first side edge, a portion of the first bumper rib which faces the airfoil adjacent thereto, the first sealing flap, a portion of the second bonding segment that is bonded to the inner surface, a portion of the second bumper rib that is bonded to the second side edge, a portion of the second bumper rib which faces the airfoil adjacent thereto, and the second sealing flap.

In further accordance with another aspect of the disclosure, the first bonding segment converges with the first sealing flap at a first crook so that the first sealing flap is bendable with respect to the first bonding segment and the second bonding segment converges with the second sealing flap at a second crook so that the second sealing flap is bendable with respect to the second bonding segment.

In further accordance with yet another aspect of the disclosure, the first bumper rib may protrude from the first bonding segment adjacent to an area where the first sealing flap converges with the first bonding segment and the second bumper rib may protrude from the second bonding segment adjacent to an area where the second sealing flap converges with the second bonding segment.

In further accordance with still yet another aspect of the disclosure, the first bumper rib may include a rounded end and the second bumper rib may include a rounded end.

In further accordance with an even further aspect of the disclosure, the first bumper rib may include a squared end and the second bumper rib may include a squared end.

In accordance with another aspect of the disclosure, a method of constructing an edge seal for preventing airflow through a space between a fan platform and an adjacent airfoil in a gas turbine engine is provided. The method entails forming a bonding segment that is bondable to the fan platform. Another step may include forming a sealing flap that converges with the bonding segment so that the sealing flap is operatively contactable with the airfoil adjacent thereto. Yet another step may include forming a bumper rib that protrudes from the bonding segment so that the bumper rib is bondable to the fan platform.

In accordance with yet another aspect of the disclosure, the method may include covering the edge seal in a fabric.

In accordance with still yet another aspect of the disclosure, the method may include covering with a fabric a portion of the bonding segment that is bondable to the fan platform, a portion of the bumper rib that is bondable to the fan platform, a portion of the bumper rib which faces the airfoil adjacent thereto, and the sealing flap.

In accordance with a further aspect of the disclosure, the method may include covering the edge seal with a polyester weave.

In accordance with an even further aspect of the disclosure, the method may include forming the bumper rib to include a rounded end.

In further accordance with another aspect of the disclosure, the method may include forming the bumper rib to include a squared end.

Other aspects and features of the disclosed systems and methods will be appreciated from reading the attached detailed description in conjunction with the included drawing figures. Moreover, selected aspects and features of one example embodiment may be combined with various selected aspects and features of other example embodiments.

### BRIEF DESCRIPTION OF THE DRAWINGS

For further understanding of the disclosed concepts and embodiments, reference may be made to the following detailed description, read in connection with the drawings, wherein like elements are numbered alike, and in which:

FIG. 1 is a side view of a gas turbine engine with portions sectioned and broken away to show details of the present disclosure;

FIG. 2 is a perspective view a fan platform between adjacent airfoils with edge seals, constructed in accordance with the teachings of this disclosure;

FIG. 3 is a rear view a fan platform with edge seals, constructed in accordance with the teachings of this disclosure;

FIG. 4 is an enlarged side view of a portion of the fan platform with an edge seal of FIG. 3, constructed in accordance with the teachings of this disclosure; and

FIG. 5 is a flowchart illustrating a sample sequence of steps which may be practiced in accordance with a method of the present disclosure.

It is to be noted that the appended drawings illustrate only typical embodiments and are therefore not to be considered limiting with respect to the scope of the disclosure or claims. Rather, the concepts of the present disclosure may apply within other equally effective embodiments. Moreover, the drawings are not necessarily to scale, emphasis generally being placed upon illustrating the principles of certain embodiments.

### DETAILED DESCRIPTION

Throughout this specification the terms “downstream” and “upstream” are used with reference to the general direction of gas flow through the engine and the terms “axial”, “radial” and “circumferential”, and their derivatives, are generally used with respect to the longitudinal central axis of the engine.

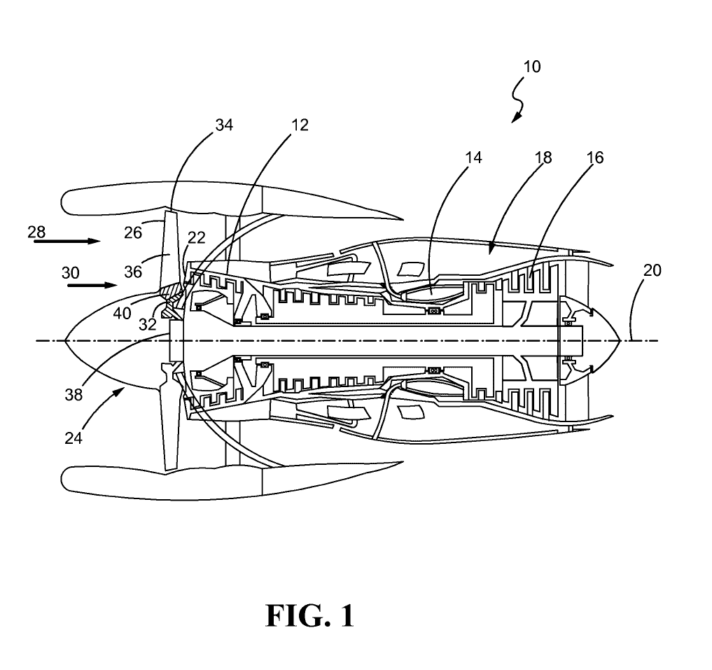

Referring now to FIG. 1, a gas turbine engine constructed in accordance with the present disclosure is generally referred to by reference numeral 10. The gas turbine engine 10 includes a compressor 12, a combustor 14 and a turbine 16. The serial combination of the compressor 12, the combustor 14 and the turbine 16 is commonly referred to as a core engine 18. The engine 10 lies along a longitudinal central axis 20.

As is well known in the art, air enters compressor 12 at an inlet 22 and is pressurized. The pressurized air then enters the combustor 14. In the combustor 14, the air mixes with jet fuel and is burned, generating hot combustion gases that flow downstream to the turbine 16. The turbine 16 extracts energy from the hot combustion gases to drive the compressor 12 and a fan 24, which includes airfoils 26. As the turbine 16 drives the fan 24, the airfoils 26 rotate so as to take in more ambient air. This process accelerates the ambient air 28 to provide the majority of the useful thrust produced by the engine 10. Generally, in modern gas turbine engines, the fan 24 has a much greater diameter than the core engine 18. Because of this, the ambient air flow 28 through the fan 24 can be 5-10 times higher, or more, than the combustion air flow 30 through the core engine 18. The ratio of flow through the fan 24 relative to flow through the core engine 18 is known as the bypass ratio.

Each airfoil 26 includes a root 32, a tip 34 and a midspan portion 36 extending between the root 32 and the tip 34. The fan 24 also includes a fan rotor 38. The airfoils 26 radially outwardly extend circumferentially around the fan rotor 38. Fan platforms 40 extend from the fan rotor 38 with each fan platform 40 in between adjacent airfoils 26.

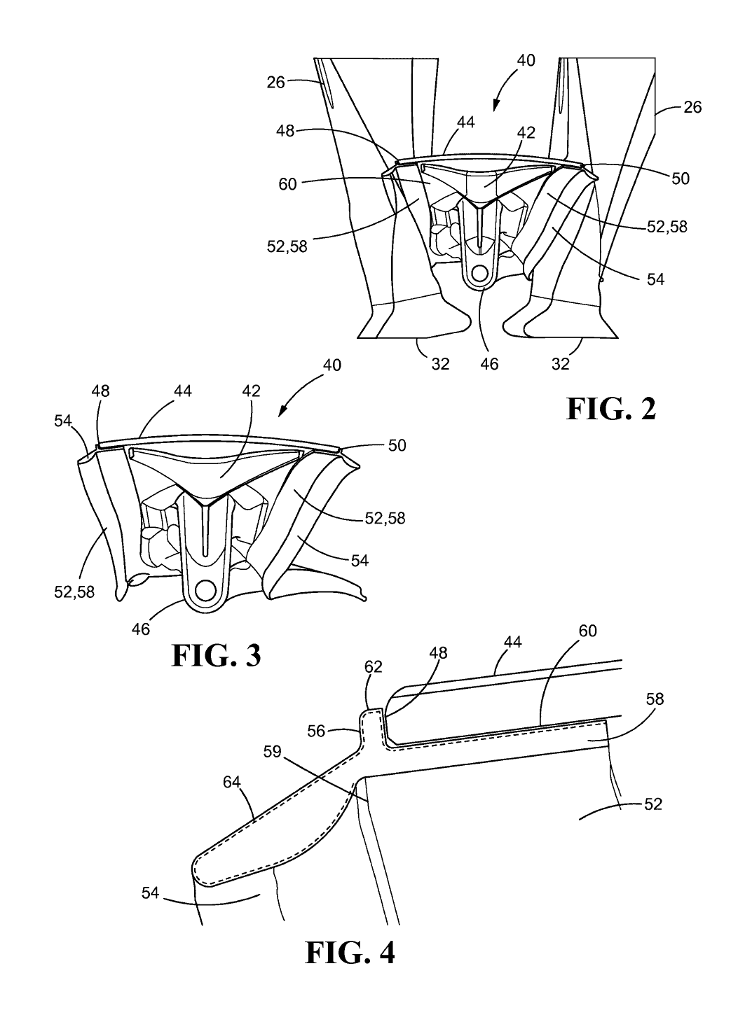

As best seen in FIGS. 2 and 3, the fan platform 40 includes a body portion 42 and a flowpath surface portion 44. The body portion 42 may include a plurality of devises 46 for attachment to the fan rotor 38. The flowpath surface portion 44 extends between a first and second side edge 48, 50. Each fan platform 40 may include an edge seal 52 along the first side edge 48 and an edge seal 52 along the second side edge 50. The edge seals 52 may be formed from, but not limited to, silicone.

Referring to FIGS. 2-4, each edge seal 52 may be formed of a sealing flap 54, a bumper rib 56 and a bonding segment 58. The sealing flap 54 converges with the bonding segment 58 at a crook 59 so that the sealing flap 54 is bendable with respect to the bonding segment 58. The bumper rib 56 protrudes from the bonding segment 58 adjacent to the area where the sealing flap 54 converges with the bonding segment 58. With particular reference to FIG. 4, the bonding segment 58 may be bonded to the inner surface 60 of the flowpath surface portion 44 and the bumper rib 56 may be bonded along the first side edge 48, so that the sealing flap 54 is in operative sealing contact with an adjacent airfoil 26. The edge seal 52 associated with the second side edge 50 may be similarly arranged such that its bonding segment 58 is bonded to the inner surface 60 and its bumper rib 56 is bonded along the second side edge 50, so that its sealing flap 54 is in operative contact with an adjacent airfoil 26. The bumper rib 56, acting as a locating feature for the edge seal 52, may include an end 62, which may be substantially rounded or squared.

Portions of edge seal 52 may be covered with a fabric 64, as exemplified by the dotted lines in FIG. 4. In particular, the fabric 64 may cover the portion of the bonding segment 58 that is bonded to the inner surface 60, the portion of the bumper rib 56 that is bonded to the side edges 48, 50, the portion of the bumper rib 56 which faces the airfoil 26, and the sealing flap 54. The fabric 64 may be, but is not limited to, a polyester weave or an aramid. The fabric 64 aids in protecting the edge seals 52 from wear and facilitates in bonding to the fan platform 40.

During engine 10 operation, the centrifugal force urges the sealing flap 54 into sealing contact with an adjacent airfoil 26 so as to prevent airflow through the spaces between the fan platforms 26 and the airfoils 26. The bumper rib 56 facilitates in preventing the sealing flap 54 from shifting towards the inner surface 60 so that the sealing flap 54 maintains sealing contact with the airfoil 26. In addition, as the fan platform 40 may rotate slightly during operation, the bumper rib 56 protects the side edges 48, 50 from direct contact with an adjacent airfoil 26. Accordingly, the bumper rib 56 prevents wear damage of the airfoils 26 and the fan platforms 40 and increases the life of these parts.

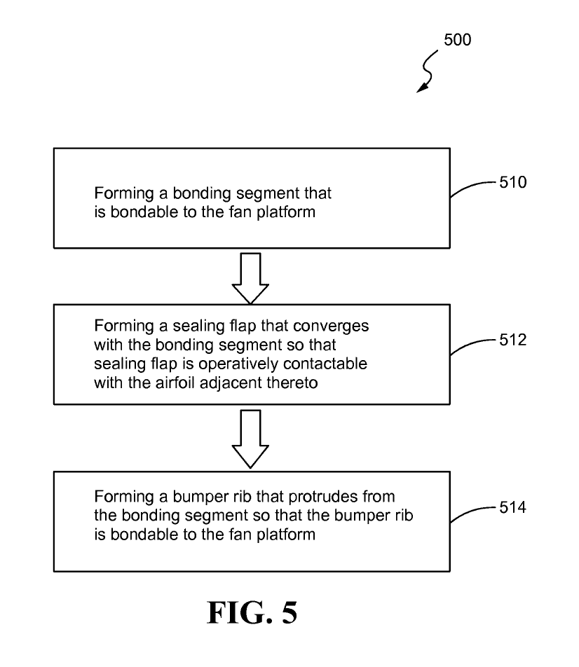

FIG. 5 illustrates a flowchart 500 of a method of constructing an edge seal for preventing airflow through a space between a fan platform and an adjacent airfoil in a gas turbine engine. Box 510 shows the step of forming a bonding segment that is bondable to the fan platform. Another step, as shown in box 512, is forming a sealing flap that converges with the bonding segment so that the sealing flap is operatively contactable with the airfoil adjacent thereto. Box 514 illustrates the step of forming a bumper rib that protrudes from the bonding segment so that the bumper rib is bondable to the fan platform. The edge seal may be covered in fabric. The fabric may be a polyester weave. In particular, a portion of the bonding segment that is bondable to the fan platform, a portion of the bumper rib that is bondable to the fan platform, a portion of the bumper rib which faces the airfoil adjacent thereto, and the sealing flap all may be covered in fabric. The bumper rib may include an end, which may be rounded or squared.

While the present disclosure has shown and described details of exemplary embodiments, it will be understood by one skilled in the art that various changes in detail may be effected therein without departing from the spirit and scope of the disclosure as defined by claims supported by the written description and drawings. Further, where these exemplary embodiments (and other related derivations) are described with reference to a certain number of elements it will be understood that other exemplary embodiments may be practiced utilizing either less than or more than the certain number of elements.

### INDUSTRIAL APPLICABILITY

Based on the foregoing, it can be seen that the present disclosure sets forth an edge seal for preventing airflow through a space between a fan platform and an adjacent airfoil in a gas turbine engine. The teachings of this disclosure can be employed to manufacture an edge seal having a bumper rib that acts as a locating feature for the edge seal. Moreover, the bumper rib protects the fan platform from direct contact with an airfoil adjacent thereto. As such, the bumper rib prevents wear damage of the airfoils and the fan platforms and increases the life of these parts

What is claimed is:

1. An edge seal for preventing airflow through a space between a fan platform and an adjacent airfoil in a gas turbine engine, the edge seal comprising:
a bonding segment being bondable to the fan platform;
a sealing flap converging with the bonding segment, the sealing flap being operatively contactable with the adjacent airfoil; and
a bumper rib protruding from the bonding segment, the bumper rib being bondable to the fan platform.

2. The edge seal of claim 1, wherein the edge seal is covered in a fabric.

3. The edge seal of claim, 2, wherein the fabric covers a portion of the bonding segment that is bondable to the fan platform, a portion of the bumper rib that is bondable to the fan platform, a portion of the bumper rib which faces the adjacent airfoil, and the sealing flap.

4. The edge seal of claim 2, wherein the fabric is a polyester weave.

5. The edge seal of claim 1, wherein the bumper rib includes a rounded end.

6. The edge seal of claim 1, wherein the bumper rib includes a squared end.

7. A gas turbine engine, comprising:
a fan rotor;
a plurality of airfoils radially attached circumferentially around the fan rotor;
a plurality of fan platforms attached to the fan rotor with each of the fan platforms disposed between each of the plurality of airfoils, each of the fan platforms including a first and second side edge and an inner surface;
a first plurality of edge seals, each of the first plurality of edge seals including a first bonding segment, a first sealing flap and a first bumper rib, the first bonding segment being bonded to the inner surface, the first bumper rib being bonded to the first side edge, the first sealing flap being in operatively sealing contact with the airfoil adjacent thereto; and
a second plurality of edge seals, each of the second plurality of edge seals including a second bonding segment, a second sealing flap and a second bumper rib, the second bonding segment being bonded to the inner surface, the second bumper rib being bonded to the second side edge, the second sealing flap being in operatively sealing contact with the airfoil adjacent thereto.

8. The gas turbine engine of claim 7, wherein each of the first and second plurality of edge seals is covered in a fabric.

9. The gas turbine engine of claim 8, wherein the fabric covers a portion of the first bonding segment that is bonded to the inner surface, a portion of the first bumper rib that is bonded to the first side edge, a portion of the first bumper rib which faces the airfoil adjacent thereto, the first sealing flap, a portion of the second bonding segment that is bonded to the inner surface, a portion of the second bumper rib that is bonded to the second side edge, a portion of the second bumper rib which faces the airfoil adjacent thereto, and the second sealing flap.

10. The gas turbine engine of claim 8, wherein the fabric is a polyester weave.

11. The gas turbine engine of claim 7, wherein the first bonding segment converges with the first sealing flap at a first crook so that the first sealing flap is bendable with respect to the first bonding segment and the second bonding segment converges with the second sealing flap at a second crook so that the second sealing flap is bendable with respect to the second bonding segment.

12. The gas turbine engine of claim 11, wherein the first bumper rib protrudes from the first bonding segment adjacent to an area where the first sealing flap converges with the first bonding segment and the second bumper rib protrudes from the second bonding segment adjacent to an area where the second sealing flap converges with the second bonding segment.

13. The gas turbine engine of claim 7, wherein the first bumper rib includes a rounded end and the second bumper rib includes a rounded end.

14. The gas turbine engine of claim 7, wherein the first bumper rib includes a squared end and the second bumper rib includes a squared end.

15. A method of constructing an edge seal for preventing airflow through a space between a fan platform and an adjacent airfoil in a gas turbine engine, comprising:
forming a bonding segment that is bondable to the fan platform;
forming a sealing flap that converges with the bonding segment so that the sealing flap is operatively contactable with the airfoil adjacent thereto; and
forming a bumper rib that protrudes from the bonding segment so that the bumper rib is bondable to the fan platform.

16. The method of claim 15, further including covering the edge seal in a fabric.

17. The method of claim 15, further including covering with a fabric a portion of the bonding segment that is bondable to the fan platform, a portion of the bumper rib that is bondable to the fan platform, a portion of the bumper rib which faces the airfoil adjacent thereto, and the sealing flap.

18. The method of claim 16, wherein the fabric is a polyester weave.

19. The method of claim 15, furthering including forming the bumper rib to include a rounded end.

20. The method of claim 15, furthering including forming the bumper rib to include a squared end.
